(19) United States
(12) Patent Application Publication
(10) Pub. No.: US 2020/0001761 A1
(43) Pub. Date: Jan. 2, 2020

(54) ARMREST ASSEMBLY FOR A VEHICLE SEAT AND VEHICLE SEAT HAVING SUCH AN ARMREST ASSEMBLY

(71) Applicants: Bogdan TUTELEA, Leichlingen (DE); Wolfgang SITZLER, Wuppertal (DE); Tanja PINK, Wuppertal (DE); Andreas GÖBBELS, Kürten (DE); Hartmut BOHLKE, Wuppertal (DE); Jan BODDENBERG, Köln (DE)

(72) Inventors: Bogdan TUTELEA, Leichlingen (DE); Wolfgang SITZLER, Wuppertal (DE); Tanja PINK, Wuppertal (DE); Andreas GÖBBELS, Kürten (DE); Hartmut BOHLKE, Wuppertal (DE); Jan BODDENBERG, Köln (DE)

(21) Appl. No.: 16/332,402

(22) PCT Filed: Aug. 8, 2017
(86) PCT No.: PCT/EP2017/070105

§ 371 Date: Mar. 12, 2019

(30) Foreign Application Priority Data
Sep. 13, 2016 (DE) 102016217453.3

(51) Int. Cl. B60N 2/75

(52) U.S. Cl. CPC B60N 2/753

(57) ABSTRACT

An armrest assembly and a vehicle seat. The armrest assembly includes an armrest body and a seat-fixed pivot joint in order to pivot the armrest body between a lowered support position and a raised idle position about a seat-fixed pivot axis. A mechanical raising aid is associated with the pivot joint, which raising aid controls a torque-producing device in accordance with pivot travel, which torque-producing device is designed to produce torque on the armrest body in the raising direction. The armrest assembly may be used in passenger vehicles.

The invention relates to an armrest assembly for a vehicle seat, comprising an armrest body, and comprising a seat-mounted pivot joint in order to pivot the armrest body between a lowered resting position and a raised idle position about a seat-mounted pivot axis, and to a vehicle seat comprising such an armrest assembly.

A vehicle seat for a bus for transporting people is known in general. The vehicle seat has a seat surface and a backrest. In addition, the vehicle seat is provided with at least one armrest assembly which has an armrest body. The armrest body is mounted by means of a pivot joint fastened on the seat side so as to be pivotable between an approximately horizontal resting position and an idle position raised upward next to a side cheek of the backrest. For the armrest body, the pivot joint defines a pivot axis which is arranged in a stationary manner with respect to the vehicle seat and extends transversely in the direction of a width of the vehicle seat.

It is the object of the invention to provide an armrest assembly and a vehicle seat of the type mentioned at the beginning, permitting increased comfort for a person on the vehicle seat.

This object is achieved for the armrest assembly in that the pivot joint is assigned a mechanical raising aid which, in a manner depending on pivoting distance, controls a torque-generating device which is designed for generating torque on the armrest body in the raising direction. According to the invention, the mechanical raising aid assists raising of the armrest body into the idle position, as a result of which a person on the vehicle seat can effortlessly pivot the armrest body from the resting position into the idle position. A dead weight of the armrest body that the person has to overcome during the raising can be reduced by the solution according to the invention. In addition, the mechanical raising aid permits ergonomically particularly favorable pivoting of the armrest body. This is because the person wishing to raise the armrest body merely has to initiate the pivoting movement of the armrest body from the resting position. The mechanical raising aid at least substantially automatically takes over the further pivoting of the armrest body into the raised idle position. The solution according to the invention is suitable in a particularly advantageous manner for wheeled vehicles in the form of buses, high capacity limousines or vans. In the same manner, the solution according to the invention is usable in rail vehicles or in aircraft, advantageously there in each case in the passenger region, i.e. in the people transport region. The solution according to the invention can be used particularly advantageously for small buses, camping buses or motorhomes. A vehicle seat provided with the armrest assembly according to the invention preferably has a respective armrest assembly on both sides of a seat region.

In a refinement of the invention, the torque-generating device has a mechanical spring drive, and control kinetics are provided which switch the spring drive to active or inactive depending on a pivoting distance of the armrest body. The control kinematics form a control mechanism. The spring drive is provided in such a manner that it exerts a torque on the armrest body in the direction of the raised idle position. The torque-generating device is preferably positioned in the region of the pivot joint of the armrest body. A torsion spring or a leg spring which is prestressed in the resting position of the armrest body is preferably provided as the spring drive.

In a further refinement of the invention, the control kinematics have a seat-mounted control contour which is coaxial with respect to the pivot axis, and a control member is provided which is assigned to the spring drive, is arranged on a pivotable part of the pivot joint and interacts with the control contour. The control member interacts with the control contour during a pivoting movement of the pivotable part of the pivot joint and therefore during a pivoting movement of the armrest body.

In a further refinement of the invention, the control member interacts with a seat-mounted counter support of the pivot joint in order to generate a torque on the pivotable part of the pivot joint. The counter support is arranged eccentrically relative to the control member. Since the counter support is positioned in a stationary manner, interaction of the control member with the counter support when the spring drive is activated inevitably brings about the generation of a torque on the pivotable part of the pivot joint and therefore on the armrest body.

In a further refinement of the invention, the control contour and the counter support are spaced apart from each other in the pivoting direction in such a manner that functions of the control contour and of the counter support that act on the control member are connected to one another in series. The control contour and the counter support therefore never act simultaneously, but rather always in a temporally staggered manner with respect to each other during a corresponding pivoting movement.

In a further refinement of the invention, the control contour is configured with a first contour portion in such a manner that the control member keeps the spring drive in an inactive position over a defined pivoting distance. The first contour portion is provided in the pivoting region which begins with the resting position and extends in the direction of the raised idle position.

In a further refinement of the invention, the control contour is configured with a second contour portion in such a manner that the control member is released for activation of the spring drive. The second contour portion adjoins the first contour portion—as seen in the pivoting direction from the resting position in the direction of the idle position—and permits the generation of torque by the spring drive which is switched to inactive in the region of the first contour portion.

In a further refinement of the invention, the counter support interacts with the control member for transmitting a torque of the spring drive to the pivotable part of the pivot joint. The control member is supported on the counter support and, on account of its eccentric positioning, thus brings about the desired generation of torque on the pivotable part of the pivot joint.

In a further refinement of the invention, the control member is configured as a quarter of a mechanical Maltese cross. This is a particularly advantageous configuration which can be simply produced and can be realized in a functionally reliable manner.

In a further refinement of the invention, the pivot joint has end stops for limiting pivotability of the armrest body in the idle position and the resting position. The end stops serve to limit pivotability of the armrest body to the region between the idle position and the resting position.

For the vehicle seat, the object on which the invention is based is achieved in that the vehicle seat is provided with at least one armrest assembly as has been previously described.

Further advantages and features of the invention emerge from the claims and from the description below of a preferred exemplary embodiment of the invention that is illustrated with reference to the drawings.

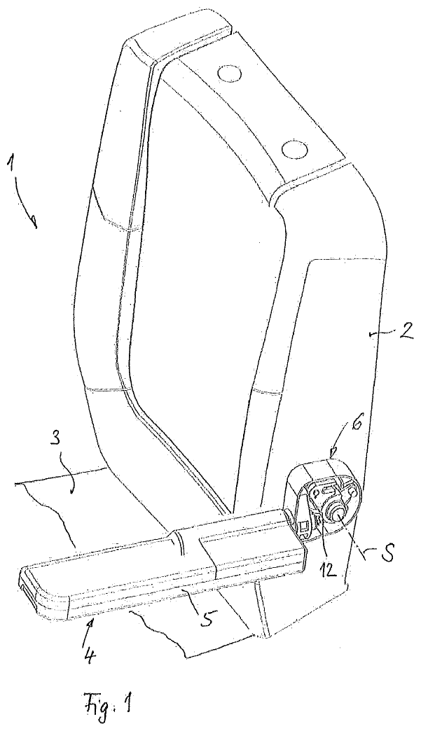

FIG. 1 shows perspectively a partial region of an embodiment of a vehicle seat according to the invention with an embodiment of an armrest assembly according to the invention in a resting position,

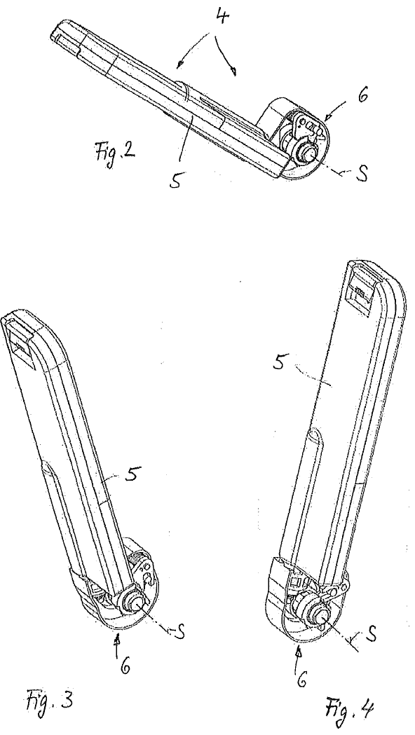

FIG. 2 and FIG. 3 show the armrest assembly according to FIG. 1 in various intermediate positions between the resting position and a raised idle position,

FIG. 4 shows the armrest assembly according to FIG. 1 to FIG. 3 in the raised idle position,

FIG. 5 shows, in an enlarged exploded illustration, a pivot joint of the armrest assembly according to FIG. 1 to FIG. 4, and

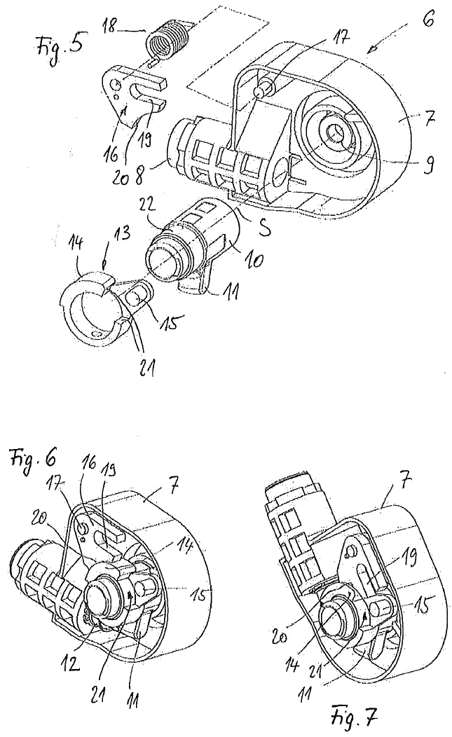

FIG. 6 to FIG. 11 show, in a perspective illustration, different positions of the pivot joint between the resting position of the armrest body (FIG. 6) and the raised idle position of the armrest body (FIG. 11).

A vehicle seat 1 is provided for a passenger vehicle in the form of a high capacity limousine, a van or a small bus. The vehicle seat 1 has a seat surface 3 which is only partially illustrated and which is adjoined on the rear side by a backrest 2. The backrest 2 and the seat surface 3 are arranged in a stationary manner in the passenger vehicle, but can be adjustable. On its opposite sides, the backrest 2 has a respective side cheek on which an armrest assembly 4 is arranged. In the illustration according to FIG. 1, only the left side cheek of the backrest 2 is provided with an armrest assembly 4. However, the opposite right side cheek of the backrest 2 can be provided in the same manner with a mirror-symmetrical, but otherwise identical armrest assembly 4. In a manner not illustrated specifically, the vehicle seat has a dimensionally stable supporting structure which is positioned both in the region of the backrest 2 and in the region of the seat surface. The supporting structure forms a frame for the backrest 2 and the seat surface 3 and is covered by upholstery and a seat cover of the backrest 2 and the seat surface 3.

In one exemplary embodiment (not illustrated) of the invention, the armrest assembly 4 is not arranged in the region of side cheeks of the backrest, but rather, on the contrary, in the region of a supporting structure region for the seat surface 3. However, the basic design and the basic function of such an armrest assembly do not differ from the armrest assembly 4 according to FIG. 1 to FIG. 11.

The armrest assembly 4 has an armrest body 5 which is mounted pivotably about a pivot axis S by means of pivot joint on the seat side, namely in the region of a supporting structure portion of the side cheek of the backrest 2. The pivot axis S extends substantially in the transverse direction of the vehicle if it is assumed that the armrest body 5 in its resting position according to FIG. 1 extends substantially horizontally and forward in the longitudinal direction of the vehicle. The armrest body 5 is mounted pivotably by means of the pivot joint 6 between the resting position illustrated in FIG. 1 and a raised idle position (FIG. 4). In the raised idle position, the armrest body 5 extends approximately parallel to the backrest 2 and is positioned directly adjacent next to the left side cheek of the armrest 2.

The pivot joint 6 has a seat-mounted shaft region which is coaxial with respect to the pivot axis S and is connected fixedly to a seat back supporting structure. In addition, the pivot joint 6 has a pivotable part which comprises a pivot housing 7 (see in particular FIG. 5). The armrest body 5 is fastened to the pivot housing 7, which is mounted rotatably about the pivot axis S relative to the stationary shaft region of the pivot joint 6. For this purpose, the pivot housing 7 has an extension 8 to which the armrest body 5 is fastened. The fixed shaft region 9 of the pivot joint 6 has a rotary bearing (not denoted specifically) for the pivot housing 7 in order to permit the rotatability of the pivot housing 7 about the shaft region 9 coaxially with respect to the pivot axis S.

A bearing flange 10 is fastened coaxially on the shaft region 9, said bearing flange being provided with an end stop 11 on which a supporting extension 12 of the armrest body 5 is supported in the resting position of the armrest body 5 (FIG. 1 and FIG. 6). The end stop 11 is integrally formed on the bearing bolt 10 and protrudes downward from the bearing bolt 10 radially with respect to the pivot axis S. In addition, the bearing bolt 10 has an annular receiving flange 22, onto which a control ring 13 is pushed and is fixed both axially and also in the direction of rotation. The control body 13 firstly has a control contour 14 in the shape of an arc of a circle and secondly a cylindrical control cam 15 which serves as a counter support within the context of the invention. The control contour 14 in the shape of an arc of a circle extends over part of a cylindrical circumference of the annular control body 13. The control contour 14 is adjoined by a recess 21 which is in the shape of an arc of a circle and in relation to which the cylindrical control cam 15 is arranged offset radially outward. The control cam 15 is provided on a radially outwardly extended tab extension of the control body 13. The control cam 15 is oriented in a manner offset radially outward axially parallel to the pivot axis S. The control contour 14 in the shape of an arc of a circle is oriented coaxially with respect to the pivot axis S and accordingly forms a partially cylindrical circumferential surface which is coaxial with respect to the pivot axis S. The recess 21 is part of the control contour and is configured in the shape of a portion of a circular ring and adjoins the control contour 14 in the circumferential direction coaxially with respect to the pivot axis S. In the mounted state, the control body 13 is fastened to the stationary shaft region 9 in a manner secured both axially and in the circumferential direction.

The control contour 14 and the recess 21 form the first and second contour portions adjoining one another in the circumferential direction within the context of the invention.

The pivot housing 7 of the pivot joint 6 is configured in a trough-or drop-shaped manner. Both the bearing bolt 10 and the control body 13 are integrated in the pivot housing 7. In the ready mounted state of the pivot joint 6, the pivot housing 7 is closed in a manner not illustrated specifically by a cover in the region of its laterally outwardly facing end side.

A bearing pin 17 is provided radially offset with respect to the shaft region 9 and therefore eccentrically with respect to the pivot axis S, said bearing pin having a central longitudinal axis which is parallel to the pivot axis S. The bearing pin 17 is fastened to a base of the pivot housing 7. Since the pivot housing 7 rotates together with the armrest body 5 during a pivoting movement, the bearing pin 17 is inevitably also pivoted together with the pivot housing 7 relative to the pivot axis S. A torsion spring 18 which is supported firstly on the pivot housing 7 and secondly on a control member 16 is arranged coaxially with respect to the bearing pin 17. The control member 16 is mounted rotatably about its center longitudinal axis on the bearing pin 17. Accordingly, an axis of rotation of the control member 16 runs parallel to the pivot axis S. Eccentrically with respect to the axis of rotation which is defined by the bearing pin 17, the control member 16 has a supporting groove 19 which is open toward an end side and extends outward radially with respect to the axis of rotation of the control member 16. In addition, a concave outer contour of the control member 16 is provided in the radial plane of the supporting groove 19 and therefore of the control member 16, said outer contour running in the shape of an arc of a circle and having the same radius as the control contour 14 of the stationary control body 13.

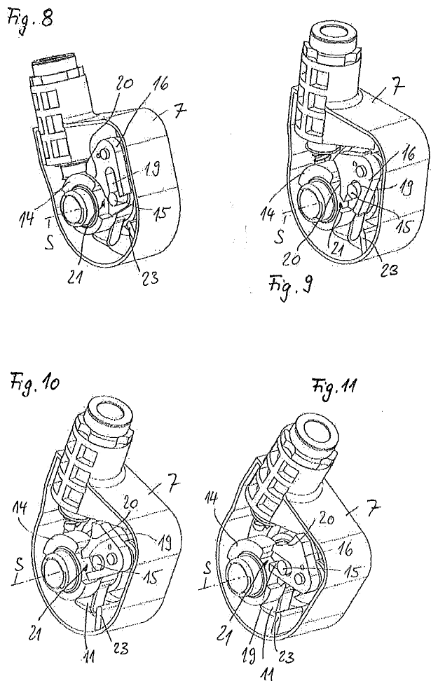

In the resting position of the armrest body 5 (FIG. 1 and FIG. 6), the concave outer contour 20 of the control member 16 is supported flush and coaxially on the stationary control contour 14, which serves as the first control portion, of the control body 13. The control member 16 is prestressed in this position by the spring drive 18, which is configured as a torsion spring, and therefore a torque of the spring drive 18 about the axis of rotation defined by the bearing pin acts on the control member 16 and runs in the clockwise direction according to the illustrations in FIG. 5 to FIG. 11. By the support of the control member 16 with its concave outer contour 20 on the stationary control contour 14 of the control body 13, said torque applied by the spring drive 18 is ineffective, i.e. the spring drive 18 is switched to inactive. At the same time, the outer contour 20 presses substantially with its full area against the control contour 14 and thus forms a friction pairing with the control contour, said friction pairing firstly damping vehicle vibrations on account of the mutual support and secondly, by means of the frictional force applied because of the prestressing of the spring drive 18, bringing about a uniform, damped first pivoting phase from the resting position. As soon as the armrest body 5 according to the illustration of FIG. 2 to FIG. 4 and FIG. 7 to FIG. 11 is then pivoted out of the resting position in the direction of the raised idle position, the outer contour 20 slides along the control contour 14 and the open supporting groove 19 approaches the control cam 15 which serves as a counter support and is likewise positioned in a stationary manner. As soon as the control member 16, during its pivoting upward in the clockwise direction, has reached, with its outer contour 20, the recess 21 forming the second contour portion, the spring drive 18 becomes active. At the same time, the supporting groove 19 comes into contact with the supporting cam 15, as a result of which the supporting cam 15 inevitably enters the supporting groove 19 during further rotation of the armrest body 5 (see FIG. 8 and FIG. 9). Since the control member 16 is supported eccentrically with respect to its axis of rotation, which is defined by the bearing pin 17, on the supporting cam 15, the spring drive 18 brings about a torque on the pivot housing 7 about the pivot axis S. In this second phase of the raising movement, friction no longer acts between the outer contour 20 and the control contour 14, and therefore all of the energy of the spring drive 18 is available for the raising movement.

The pivot housing 7 has, in its inner region, an end stop 23 which comes into contact with the stationary stop cam 11 as soon as the armrest body 5 has reached the raised idle position. Accordingly, the end stop 23 and the stop cam 11 define the limiting of the pivotability of the armrest body 5 upward in the pivoting direction. The control member 16 has rotated further in relation to the supporting cam 15 in the manner of an eccentric disk, with the torque assistance by the spring drive 18 bringing about automatic raising of the armrest body 5 as soon as the control member is disengaged from the control contour 14.

During pivoting of the armrest body 5 in the reverse direction, i.e. from the raised idle position according to FIG. 4 into the lowered resting position according to FIG. 1, an operator has to overcome the torque, which acts on the armrest body 5, of the spring drive 18 until the concave outer contour 20 of the control member 16 is again in sliding contact with the control contour 14. The spring drive 18 is then inevitably deactivated, as a result of which the armrest body 5 with assistance of its dead weight can be pivoted downward in a simple manner into the resting position by the operator.

It can readily be seen with reference to FIG. 5 that the control member 16 is configured in function and appearance in accordance with a partial portion of a Maltese cross, in particular in accordance with a quarter of a Maltese cross.

1. An armrest assembly for a vehicle seat, comprising an armrest body, and comprising a seat-mounted pivot joint in order to pivot the armrest body between a lowered resting position and a raised idle position about a seat-mounted pivot axis, wherein the pivot joint is assigned a mechanical raising aid which, in a manner depending on pivoting distance, controls a torque-generating device which is designed for generating torque on the armrest body in the raising direction, wherein the torque-generating device has a mechanical spring drive, and control kinematics are provided which switch the spring drive to active or inactive depending on a pivoting distance of the armrest body.

2. (canceled)

3. The armrest assembly as claimed in claim 1, wherein the control kinematics have a seat-mounted control contour which is coaxial with respect to the pivot axis, and a control member is provided which is assigned to the spring drive, is arranged on a pivotable part of the pivot joint and interacts with the control contour.

4. The armrest assembly as claimed in claim 3, wherein the control member interacts with a seat-mounted counter support of the pivot joint in order to generate a torque on the pivotable part of the pivot joint.

5. The armrest assembly as claimed in claim 4, wherein the control contour and the counter support are spaced apart from each other in the pivoting direction in such a manner that functions of the control contour and of the counter support that act on the control member are connected to one another in series.

6. The armrest assembly as claimed in claim 5, wherein the control contour is configured with a first control portion in such a manner that the control member keeps the spring drive in an inactive position over a defined pivoting distance.

7. The armrest assembly as claimed in claim 6, wherein the control contour is configured with a second contour portion in such a manner that the control member is released for activation of the spring drive.

8. The armrest assembly as claimed in claim 4, wherein the counter support interacts with the control member for transmitting a torque of the spring drive to the pivotable part of the pivot joint.

9. The armrest assembly as claimed in claim 3, wherein the control member is configured as a quarter partial section of a mechanical Maltese cross gear.

10. The armrest assembly as claimed in claim 1, wherein the pivot joint has end stops for limiting pivotability of the armrest body in the idle position and the resting position.

11. A vehicle seat comprising at least one armrest assembly as claimed in claim 1.
